(19) United States
(12) Patent Application Publication
(10) Pub. No.: US 2001/0055080 A1
(43) Pub. Date: Dec. 27, 2001

(54) LIQUID CRYSTAL DISPLAY DEVICE

(76) Inventors: KATSUYUKI NAITO, TOKYO (JP); HIROKI IWANAGA, YOKOHAMA-SHI (JP); AIRA HOTTA, TOKYO (JP); KAZUYUKI SUNOHARA, YOKOHAMA-SHI (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 08/811,219

(22) Filed: Mar. 5, 1997

(30) Foreign Application Priority Data
Mar. 6, 1996 (JP) 8-049034

(51) Int. Cl. G02F 1/1347

(52) U.S. Cl. 349/79

(57) ABSTRACT

A liquid crystal display device of this invention includes a yellow guest-host liquid crystal layer, a magenta guest-host liquid crystal layer, and a cyan guest-host liquid crystal layer. The absorption spectrum of each color has at least two absorption peaks, and the absorbance of the second largest absorption peak is 80% or more that of the largest absorption peak.

### BACKGROUND OF THE INVENTION

The present invention relates to a liquid crystal display device and, more particularly, to a reflection type color liquid crystal display device.

Many liquid crystal display devices have been proposed as display devices for displays of information apparatuses. At present, liquid crystal display devices using nematic liquid crystals are widely used. Representative examples of display devices using nematic liquid crystals are the types of a TN (twisted nematic) mode disclosed in Jpn. Pat. Appln. KOKAI Publication No. 47-11737 and an STN (super twisted nematic) mode disclosed in Jpn. Pat. Appln. KOKAI Publication No. 60-107020.

Display systems of this sort have the advantages that the power consumption is much smaller than that of a CRT (Cathode Ray Tube) display and a thin display can be realized. Accordingly, these display devices are extensively used in information apparatuses such as personal computers and wordprocessors. However, this type of display device must use a polarizer. Since a polarizer absorbs incident light, incident light is not effectively used in the display. Additionally, when a color filter is attached to this display, the amount of transmitted light is decreased, so a more powerful light source is necessary. Therefore, a light source (backlight) is additionally provided behind a liquid crystal display device in many displays of this sort.

Unfortunately, in displays using the above conventional display devices, the brightness and the power consumption conflict with each other: the power of a light source is equivalent to the power comsumption of a liquid crystal display device including a driving circuit. Accordingly, a display incorporating a light source of this sort is unsuitable for a display of a portable information apparatus powered by a battery. Also, fluorescent backlights generally used are undesirable because they fatigue the eye when the user keeps watching the display. Therefore, a bright display of reflection type using no backlight is being demanded.

Furthermore, projection displays are also being demanded to incorporate a display device which decreases the size, prolongs the operating life, reduces the power comsumption, and improves the light transmittance of a display.

To meet these demands, liquid crystal display systems using no polarizer have been proposed. A White-Taylor type guest-host (GH) system (J. Appl. Phys. Vol. 45, pp. 4718-4723 (1974)) is an example. This GH system uses a liquid crystal composition in which a dichroic dye is mixed in a liquid crystal having a chiral nematic phase. In the GH system, the arrangement of liquid crystal molecules arranged parallel to the substrate surface changes due to application of a voltage, the direction of molecules of the dichroic dye changes accordingly, and this changes the light transmittance. In this display system, a twisted structure resulting from the chiral nematic phase allows the dye to efficiently absorb light. In principle, therefore, high display contrast can be obtained without using any polarizer.

Color reflective displays using the GH system have also been proposed. Jpn. Pat. Appln. KOKAI Publication No. 56-35168 has disclosed a reflective liquid crystal display device which realizes a full-color display by stacking three GH liquid crystal layers of yellow, magenta, and cyan. Jpn. Pat. Appln. KOKAI Publication No. 53-81251 has disclosed a liquid crystal display device in which GH liquid crystal layers of the three colors separated in microspaces are juxtaposed.

Unfortunately, the conventional GH liquid crystal guest dye molecules have been developed primarily for black-and-white shutters, so each color generally has a broad absorption spectral width. Accordingly, it is difficult for the full-color GH liquid crystal display as described above to simultaneously achieve beautiful colors and high contrast.

### BRIEF SUMMARY OF THE INVENTION

It is an object of the present invention to provide a liquid crystal display device which simultaneously achieves beautiful colors and high contrast and is suited to a color reflective display.

According to the present invention, there is provided a liquid crystal display device comprising a yellow guest-host liquid crystal layer, a magenta guest-host liquid crystal layer, and a cyan guest-host liquid crystal layer, wherein an absorption spectrum of each color has at least two absorption peaks, and an absorbance of the second largest absorption peak is 80% or more of an absorbance of the largest absorption peak.

According to the present invention, there is provided a liquid crystal display device comprising a yellow guest-host liquid crystal layer, a magenta guest-host liquid crystal layer, and a cyan guest-host liquid crystal layer, wherein a half-width of an absorption spectrum of yellow is 60 nm to 110 nm, a half-width of an absorption spectrum of magenta is 70 nm to 110 nm, and a half-width of an absorption spectrum of cyan is 80 nm to 130 nm.

According to the present invention, there is provided a liquid crystal display device comprising a guest-host liquid crystal layer, wherein the guest-host liquid crystal layer contains, as guest dyes, a fluorescent dichroic dye and a quenching dichroic dye which kills fluorescence resulting from the fluorescent dichroic dye.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a graph showing the absorption spectrums of conventional yellow, magenta, and cyan GH liquid crystals;

FIG. 2 is a graph showing the absorption spectrum of a conventional guest dye having two or more absorption peaks;

FIGS. 3A and 3B are graphs showing ideal box-like absorption spectrums;

FIG. 4 is a graph showing the absorption spectrums of liquid crystal compositions used in Example 1;

FIG. 5 is a sectional view showing a liquid crystal display device;

FIG. 6 is a graph showing the absorption spectrums of liquid crystal compositions used in Example 2;

FIG. 7 is a graph showing the absorption spectrums of liquid crystal compositions used in Example 3;

FIG. 8 is a graph showing the absorption spectrum of a yellow liquid crystal composition used in Example 4;

FIG. 9 is a graph showing the absorption spectrums of liquid crystal compositions used in Example 5;

FIG. 10A is a schematic view showing a liquid crystal display device in Example 6, and

FIG. 10B is a sectional view showing the liquid crystal display device in Example 6;

FIGS. 11A to 11H are views each showing the potential arrangement of the liquid crystal display device in Example 6; and

FIG. 12 is a sectional view showing a liquid crystal display device in Example 7.

### DETAILED DESCRIPTION OF THE INVENTION

A liquid crystal display device of the present invention will be described in detail below with reference to the accompanying drawings.

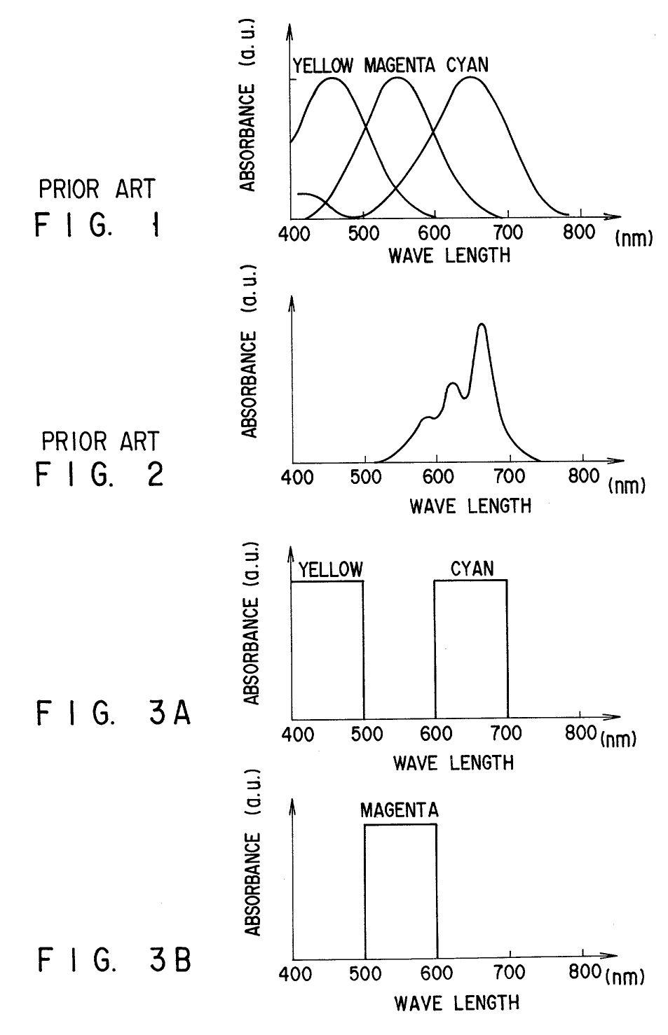

As shown in FIG. 1, the absorption spectrums of conventional yellow, magenta, and cyan GH liquid crystals generally have large half-widths, and each color has one absorption peak. Also, there is a GH liquid crystal showing an absorption spectrum having two or more absorption peaks as shown in FIG. 2. In any of these absorption spectrums, however, the intensity difference between absorption peaks is large or the half-width is broad. Even when a GH liquid crystal having such absorption peaks is used, satisfactory colors and high contrast like those of color photographs can be obtained if the light absorption ratio (selection ratio) of ON to OFF of the voltage of the GH liquid crystal is very high. However, the light absorption ratio of GH liquid crystals is not so high when no polarizing plate is used.

On the other hand, when a polarizing plate is used in a GH liquid crystal display device, the display is dark because the reflectance is low. Accordingly, to obtain satisfactory colors and high contrast with an average light absorption ratio, the device must have ideally box-like absorption spectrums as shown in FIGS. 3A and 3B. However, the realization of the absorption spectrums shown in FIGS. 3A and 3B is practically almost impossible.

The present inventors have made extensive studies on the absorption spectrums of GH liquid crystals and found that a liquid crystal display device in which the absorption spectrum has a predetermined shape and the half-width of the absorption spectrum falls within a predetermined range accomplishes colors and contrast close to those of a liquid crystal display device having the ideal absorption spectrums shown in FIGS. 3A and 3B. Thus the present inventors have achieved the present invention.

That is, a liquid crystal display device according to the first embodiment of the present invention comprises a yellow guest-host liquid crystal layer, a magenta guest-host liquid crystal layer, and a cyan guest-host liquid crystal layer, wherein the absorption spectrum of each color has at least two absorption peaks, and the absorbance of the second largest absorption peak is 80% or more of the absorbance of the largest absorption peak. This is because if the absorbance of the second largest absorption peak in the absorption spectrum is less than 80% of the absorbance of the largest peak, light absorption decreases to decrease the contrast when the half-width of the absorption spectrum is narrowed to the extent necessary to obtain satisfactory colors.

In this liquid crystal display device, light absorption can be increased without sacrificing the color quality, so higher contrast than that of a GH liquid crystal display device having the absorption spectrums shown in FIG. 1 is realized. Therefore, the absorbance of the second largest absorption peak is preferably as close to the absorbance of the largest peak as possible, and more preferably 90% or more.

Also, light absorption can be increased as the distance between the largest absorption wavelength and the wavelength of the second largest absorption peak is increased. However, the color quality is degraded when the absorption spectrum is excessively broadened. Therefore, the difference between the two wavelengths is preferably 20 nm to 80 nm.

A liquid crystal display device according to the second embodiment of the present invention comprises a yellow guest-host liquid crystal layer, a magenta guest-host liquid crystal layer, and a cyan guest-host liquid crystal layer, wherein the half-width of an absorption spectrum of yellow is 60 nm to 110 nm, the half-width of an absorption spectrum of magenta is 70 nm to 110 nm, and the half-width of an absorption spectrum of cyan is 80 nm to 130 nm.

In any of cases where the half-width of the absorption spectrum of yellow is less than 60 nm, the half-width of the absorption spectrum of magenta is less than 70 nm, and the half-width of the absorption spectrum of cyan is less than 80 nm, good colors can be obtained but the contrast decreases due to little light absorption. On the other hand, if the half-width of the absorption spectrum of yellow or magenta is larger than 110 nm or if the half-width of the absorption spectrum of cyan is larger than 130 nm, high contrast can be obtained but colors are darkened and degraded. Therefore, it is more preferable that the half-width of the absorption spectrum of yellow be 65 nm to 100 nm, the half-width of the absorption spectrum of magenta be 75 nm to 100 nm, and the half-width of the absorption spectrum of cyan be 85 nm to 110 nm.

In a reflective liquid crystal display device, the color quality and contrast are contradictory properties. Which is to be given priority depends upon the taste of the individual or the brightness of the environment. When the half-width falls within the above range, however, 90% or more of users are satisfied with both the color quality and contrast in a regular office environment.

The liquid crystal display devices according to the first and second embodiments of the present invention preferably contain a dye whose molar absorption coefficient in the maximum absorption wavelength is 10⁴ l cm⁻¹·mol⁻¹ or more. Consequently, high contrast can be obtained by addition of a small amount of dye. When the dye addition amount is small, the physical properties of the host liquid crystal are less influenced, and this is advantageous in driving the device.

These embodiments are also preferable in that the absorption spectrum can be adjusted by mixing only a small amount of dye. Accordingly, the molar absorption coefficient of the dye to be added is preferably larger, and most preferably 2×10⁴ l cm⁻¹·mol⁻¹ or more. Additionally, the molar absorption coefficient at the maximum absorption wavelength of each of the yellow, magenta, and cyan dyes is desirably 10⁴ l cm⁻¹·mol⁻¹ or more.

In the liquid crystal display devices according to the first and second embodiments of the present invention, it is preferable that the longest wavelength of the half-width of the yellow absorption spectrum be 500 nm or less, the wavelength of the half-width of the magenta absorption spectrum exists between 480 nm and 600 nm, and the shortest wavelength of the half-width of the cyan absorption spectrum be 580 nm or more. As a consequence, good colors can be obtained.

The liquid crystal display devices according to the first and second embodiments of the present invention preferably contain guest dyes having at least one skeleton selected from the group consisting of a coumarin skeleton, a polymethine skeleton, a perylene skeleton, and an indigo skeleton. These dyes are suitable as dyes for use in the liquid crystal display devices of the present invention since they have a narrow absorption spectrum half-width and a large molar absorption coefficient.

In the liquid crystal display devices according to the first and second embodiments of the present invention, it is preferable that each guest-host liquid crystal contain a plurality of types of guest dyes, and the half-width of the absorption spectrum of at least one of the guest dyes be 80 nm or less.

To approach absorption spectrums to ideal box-like spectrums as shown in FIGS. 3A and 3B by mixing a plurality of types of guest dyes, the half-width of at least one absorption spectrum is desirably 80 nm or less. Furthermore, it is readily possible to approach an absorption spectrum to the box-like spectrum by adding only a guest dye whose absorption spectrum half-width is 80 nm or less.

If, however, only a guest dye whose absorption spectrum half-width is 80 nm or less is used, it is in some instances impossible to sufficiently adjust the absorption peaks or obtain a high dichroic ratio. This can be avoided by mixing a guest dye whose absorption spectrum half-width is 80 nm or less and a guest dye whose half-width is larger than 80 nm. As the guest dye whose absorption spectrum half-width exceeds 80 nm, it is possible to use an anthraquinone-based dye or an azo-based dye with a high dichroic ratio.

In the liquid crystal display devices according to the first and second embodiments of the present invention, the guest-host liquid crystal contains at least a fluorescent dichroic dye as a guest dye. This increases the reflectance and makes a bright display possible in a reflection type display device. As the fluorescent dichroic dye, it is preferable to use a dye containing, e.g., a coumarin skeleton, a perylene skeleton, or a polymethine skeleton.

A liquid crystal display device according to the third embodiment of the present invention comprises a guest-host liquid crystal layer, wherein the guest-host liquid crystal layer contains, as guest dyes, a fluorescent dichroic dye and a quenching dichroic dye which kills fluorescence resulting from the fluorescent dichroic dye. The fluorescent dye generally has a large absorption coefficient and absorbs a large amount of light with a small addition amount. Also, fluorescence makes a bright display possible.

The fluorescent wavelength, however, which is different from the absorption wavelength, can change colors. The present inventors have found dichroic dyes which can kill fluorescence with a small addition amount without greatly affecting colors. This property of changing no colors is advantageous in a liquid crystal display device comprising a yellow guest-host liquid crystal layer, a magenta guest-host liquid crystal layer, and a cyan guest-host liquid crystal layer. The change of colors is also a problem in monochromatic-mode guest-host liquid crystals; that is, no beautiful black can be displayed. Additionally, the solubility of a dye is a problem even in the monochromatic mode. Therefore, the effect of being able to kill fluorescence of a fluorescent dye capable of large absorption with a small addition amount is appealing.

Quenching dichroic dyes having this quenching effect are generally acceptor dyes, and a quinone-based dye and an imide-based dye are suitable. In particular, an anthraquinone-based dye and a naphthoquinone-based dye have good dichroic dye characteristics and are best suited. Note that the degree of quenching can be controlled by the amount of a quenching dye with respect to the amount of fluorescent dye. Note also that the effect of a quenching dye changes in accordance with the type of fluorescent dye or quenching dye used. Generally, however, fluorescence apparently disappears when approximately equal molar amounts of a fluorescent dye and a quenching dye are added.

Examples of the liquid crystal material used in the liquid crystal display device of the present invention are fluorine-based liquid crystal, cyano-based liquid crystal, and ester-based liquid crystal. Examples of the liquid crystal material are various liquid crystal compounds represented by formulas (1) to (10) below and mixtures of these compounds.

### Formulas (1)-(10)

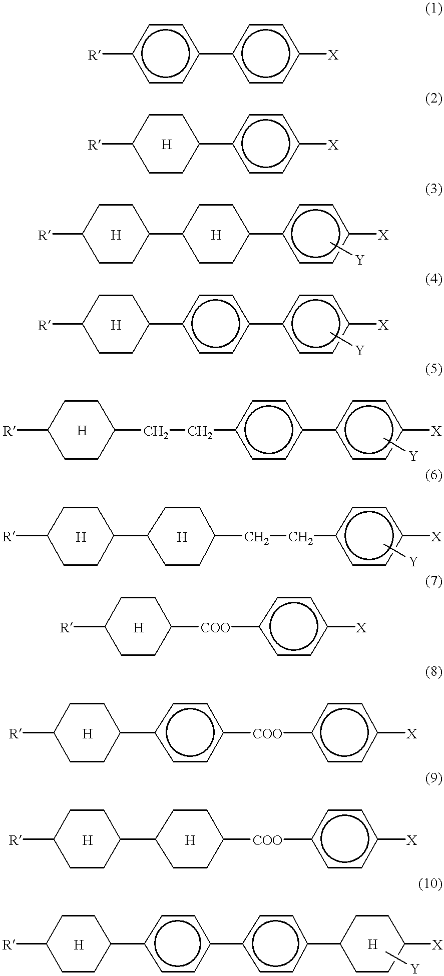

In these formulas, each of R′ and X represents an alkyl group, an alkoxy group, an alkylphenyl group, an alkoxyalkylphenyl group, an alkoxyphenyl group, an alkylcyclohexyl group, an alkoxyalkylcyclohexyl group, an alkylcyclohexylphenyl group, a cyanophenyl group, a cyano group, a halogen atom, a fluoromethyl group, a fluoromethoxy group, an alkylphenylalkyl group, alkoxyalkylphenylalkyl group, an alkoxyalkylcyclohexylalkyl group, an alkylcyclohexylalkyl group, an alkoxyalkoxycyclohexylalkyl group, an alkoxyphenylalkyl group, or an alkylcyclohexylphenylalkyl group, and Y represents a hydrogen atom or a halogen atom. These alkyl chains and alkoxy chains can have an optical active center. A phenyl group or a phenoxy group in R′ and X can be substituted with a halogen atom, e.g., a fluorine atom or a chlorine atom. Also, a phenyl group in each formula can be substituted by one or two halogen atoms, e.g., fluorine atoms or chlorine atoms.

All liquid crystal compounds represented by the above formulas have positive dielectric anisotropy. However, any known liquid crystal compound having negative dielectric anisotropy can also be used by mixing the compound with a liquid crystal compound having positive dielectric anisotropy to form a liquid crystal compound having positive dielectric anisotropy as a whole. Also, even a liquid crystal compound having negative dielectric anisotropy can be directly used by selecting a proper device construction and a proper driving method.

In the liquid crystal display of the present invention, a fluorescent dye different from the above fluorescent dye can also be used to whiten reflected light and as an ultraviolet absorbent.

When a dichroic dye is used in the liquid crystal display device of the present invention, the mixing amount is 0.01 to 10%, preferably 0.05 to 5% as a weight ratio to the liquid crystal material. If the mixing amount of dichroic dye is too small, the contrast cannot be improved sufficiently. If the mixing amount is too large, colors remain even when a voltage is applied and this also decreases contrast.

In the liquid crystal display device of the present invention, a liquid crystal layer containing a guest dye is preferably an STN liquid crystal layer. In the STN mode, the host liquid crystal is twisted 240° or more. Therefore, absorption by a dye can be increased without using any polarizing plate. Additionally, the manufacturing cost of a liquid crystal display device can be decreased because simple matrix driving is possible.

In this embodiment, however, a host liquid crystal is required to abruptly change the transmittance in a very narrow voltage width. Accordingly, in the STN mode a dye is particularly required not to disturb the physical properties of the host liquid crystal. It is considered that a dye having a large molar absorption coefficient is particularly preferable because only a small addition amount is necessary. More specifically, a highly absorptive dye with which the guest dye amount contained in the STN liquid crystal can be decreased to 1 wt % or less is preferable. That is, when a guest dye having a high dichroic ratio and a small molar absorption coefficient is used, it is necessary to dissolve the dye at a high concentration. Consequently, the contrast in the STN mode in this case is lower than that when a guest dye which has a low dichroic ratio and a large molar absorption coefficient and hence the addition amount of which need only be small is used. This is found by the present inventors.

In the liquid crystal display device of the present invention, each liquid crystal layer is preferably formed by using liquid crystal microcapsules formed by encapsulating a guest-host liquid crystal in a transparent polymer film. This microcapsulation obviates the need for insertion of a glass substrate between liquid crystal layers when the liquid crystal layers are stacked, and this prevents color migration. Additionally, the microcapsulation allows each liquid crystal layer to be formed by printing as ink, so the liquid crystal layer can be readily patterned.

As a method of manufacturing microcapsules by encapsulating a liquid crystal material and a dichroic dye in a transparent polymer film in the liquid crystal display device of the present invention, it is possible to use microcapsulation methods such as phase separation, submerged drying, interface polymerization, in-situ polymerization, submerged film hardening, and spray drying.

As the material of the transparent polymer film, it is possible to use almost all polymer materials, e.g., polyethylenes; ethylene copolymers such as chlorinated polyethylenes, an ethylene-vinyl acetate copolymer, and an ethylene.acrylic acidimaleic anhydride copolymer; polybutadienes; polyesters such as polyethyleneterephthalate, polybutyleneterephthalate, and polyethylenenaphthalate; polypropylenes; polyisobutylenes; polyvinyl chlorides; natural rubbers; polyvinylidene chlorides; polyvinyl acetates; polyvinyl alcohols; polyvinyl acetals; polyvinyl butyrals; an ethylene tetrafluoride resin; an ethylene trifluoride resin; an ethylene fluoride.propylene resin; a vinylidene fluoride resin; a vinyl fluoride resin; ethylene tetrafluoride copolymers such as an ethylene tetrafluoride.perfluoroalkoxyethylene copolymer, an ethylene tetrafluoride.perfluoroalkylvinylether copolymer, an ethylene tetrafluoride.propylene hexafluoride copolymer, and an ethylene tetrafluoride.ethylene copolymer; fluorine resins such as fluorine-containing polybenzoxazole; acrylic resins; methacrylic resins; acrylonitrile copolymers such as polyacrylonitrile and an acrylonitrile.butadiene.styrene copolymer; polystyrene and a styrene.acrylonitrile copolymer; an acetal resin; polyamides such as Nylon 66; polycarbonates; polyestercarbonates; cellulose resins; phenolic resins; urea resins; epoxy resins; unsaturated polyester resins; alkyd resins; melamine resins; polyurethanes; diarylphthalates; polyphenyleneoxides; polyphenylenesulfides; polysulfones; polyphenylsulfones; silicone resins; polyimides; bismaleimidotriazine resins; polyimidoamides; polyetherimides; polyvinylcarbazoles; norbornene-based amorphous polyolefin; and celluloses.

In the liquid crystal display device of the present invention, the yellow guest-host liquid crystal, the magenta guest-host liquid crystal, and the cyan guest-host liquid crystal can be either stacked or juxtaposed.

Examples of preferable modes in the present invention are as follows.

(1) The molar absorption coefficient in the maximum absorption wavelength is 10⁴ l·cm⁻¹·mol⁻¹ or more.

(2) The longest wavelength of the half-width of the yellow absorption spectrum is 500 nm or less, the wavelength of the half-width of the magenta absorption spectrum exists between 480 nm and 600 nm, and the shortest wavelength of the half-width of the cyan absorption spectrum is 580 nm or more.

(3) Each of the color guest-host liquid crystals contains a plurality of types of guest dyes, and the half-width of the absorption spectrum of at least one guest dye is 80 nm or less.

(4) At least one guest-host liquid crystal contains a guest dye whose absorption spectrum half-width is 80 nm or less and a guest dye whose half-width is larger than 80 nm.

(5) The guest dye whose half-width is larger than 80 nm is at least one dye selected from the group consisting of an anthraquinone-based dye and an azo-based dye.

(6) The guest dye contained in the color guest-host liquid crystals is only a guest dye whose absorption spectrum half-width is 80 nm or less.

(7) At least one guest-host liquid crystal contains a fluorescent dichroic dye as a guest dye.

(8) The guest-host liquid crystal layer comprises a yellow guest-host liquid crystal layer, a magenta guest-host liquid crystal layer, and a cyan guest-host liquid crystal layer.

(9) The guest contains a dye having at least one skeleton selected from the group consisting of a coumarin skeleton, a polymethine skeleton, a perylene skeleton, and an indigo skeleton.

(10) The liquid crystal layer is an STN liquid crystal layer.

(11) The liquid crystal layer contains liquid crystal microcapsules formed by encapsulating the guest-host liquid crystal in a transparent polymer film.

(12) The host liquid crystal is at least one liquid crystal selected from the group consisting of a fluorine-based liquid crystal, a cyano-based liquid crystal, and an ester-based liquid crystal.

(13) The fluorescent dichroic dye is a dye having at least one skeleton selected from the group consisting of a coumarin skeleton, a perylene skeleton, and a polymethine skeleton.

(14) The quenching dichroic dye is a dye having at least one skeleton selected from the group consisting of a quinone skeleton and an imide skeleton.

Examples performed to clarify the effect of the present invention will be described below.

### EXAMPLE 1

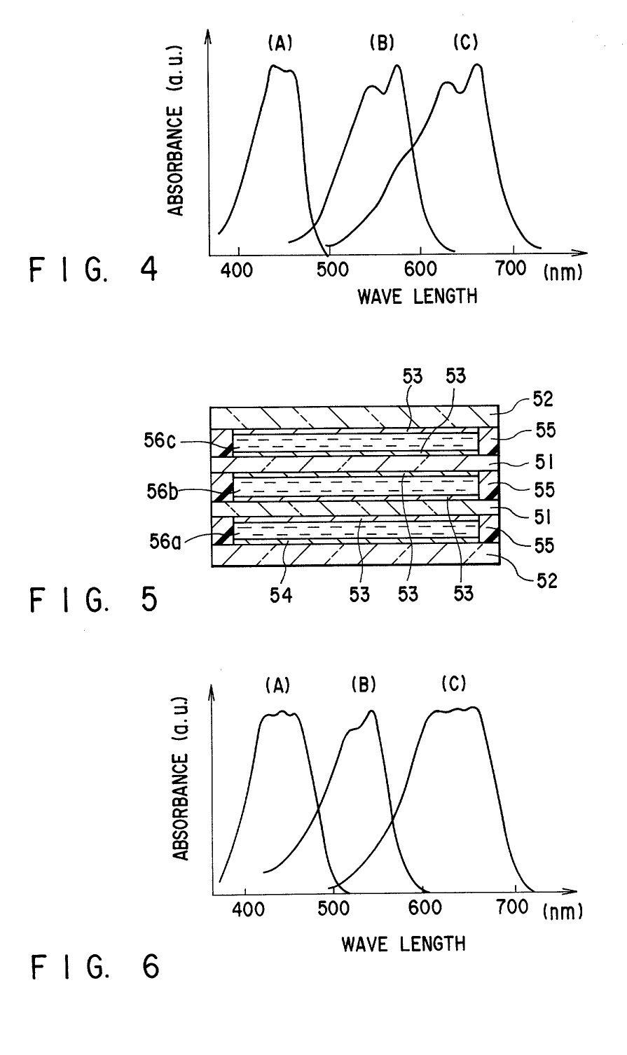

A yellow coumarin-based dichroic dye represented by formula (11) (to be presented later) was dissolved in STN liquid crystal mixture LIXON4031-000XX (tradename; available from Chisso Kagaku Kogyo K.K.) containing chiral agent S811 (tradename; available from Merck Corp.) FIG. 4 shows the absorption spectrum of the resultant material. This absorption spectrum (A) had a plurality of absorption peaks, and the absorbance of the second largest absorption peak was 98% that of the largest absorption peak. The half-width of the absorption spectrum was 64 nm.

A magenta anthraquinone-based dichroic dye represented by formula (12) (to be presented later) was dissolved in STN liquid crystal mixture LIXON4031-000XX containing chiral agent S811. FIG. 4 shows the absorption spectrum of the resultant material. This absorption spectrum (B) had a plurality of absorption peaks, and the absorbance of the second largest absorption peak was 89% that of the largest absorption peak. The half-width of the absorption spectrum was 83 nm.

A cyan polymethine-based dichroic dye represented by formula (13) (to be presented later) was dissolved in STN liquid crystal mixture LIXON4031-000XX containing chiral agent S811. FIG. 4 shows the absorption spectrum of the resultant material. This absorption spectrum (C) had a plurality of absorption peaks, and the absorbance of the second largest absorption peak was 91% that of the largest absorption peak. The half-width of the absorption spectrum was 107 nm.

Note that the molar absorption coefficients of the dichroic dye represented by formula (11) and the dichroic dye represented by formula (13) were 10⁴ 1 cm⁻¹ mol⁻¹ or more. The concentration of each dichroic dye was so adjusted that the absorbance at the maximum absorption wavelength was 0.4 when the dye was encapsulated in a cell (to be described later).

Subsequently, ITO films were formed on both surfaces of each of two 0.3-mm thick glass plates 51 shown in FIG. 5 and patterned to form transparent electrodes 53. Meanwhile, an ITO film was formed on one surface of a 1-mm thick glass substrate 52 and patterned to form a transparent electrode 53. An aluminum film was formed on one surface of another 1-mm thick glass substrate 52 and patterned to form a reflecting electrode 54.

Polyimide films were formed by coating on all of the transparent electrodes 53 and the reflecting electrode 54 and rubbed. Subsequently, glass spacers 9 μm in diameter were scattered on the polyimide film of the glass substrate 52 having the reflecting electrode 54. The glass substrate 51 having the transparent electrodes 53 on its both surfaces was stacked on the glass substrate 52, and the portion between the glass substrates 51 and 52 was sealed with an epoxy-based sealing agent 55. Additionally, the glass spacers were scattered on the polyimide film of the glass substrate 51, the other glass substrate 51 having the transparent electrodes 53 on its both surfaces was stacked, and the portion between the two glass substrates 51 was sealed with the epoxy-based sealing agent 55. Furthermore, the glass spacers were scattered on the polyimide film of the glass substrate 51, the glass substrate 52 having the transparent electrode 53 on its one surface was stacked, and the portion between the glass substrates 51 and 52 was sealed with the epoxy-based sealing agent 55. In this manner a cell as shown in FIG. 5 was manufactured. The length of the diagonal line of this cell was four inches, and the number of pixels was 320×240.

Subsequently, the liquid crystal compositions described above were encapsulated in the respective liquid crystal encapsulating portions of the cell. The result was a guest-host liquid crystal display device in which the first layer was a magenta liquid crystal layer 56a, the second layer was a yellow liquid crystal layer 56b, and the third layer was a cyan liquid crystal layer 56c. Note that the combination (order of stacking) of colors of the liquid crystal layers 56a to 56c can also be changed.

This liquid crystal display device was driven with a voltage of 2 V and a voltage width of 0.2 V. Consequently, the white-to-black contrast ratio was 3.4 and bright white was displayed by fluorescence of the coumarin dye. Also, a satisfactory color quality was obtained although black was slightly greenish.

### EXAMPLE 2

A liquid crystal display device was manufactured following the same procedure as in Example 1 except that a mixture of yellow coumarin-based dichroic dyes represented by formulas (11) and (14) (to be presented later) was used instead of the yellow dye represented by formula (11), a magenta anthraquinone-based dichroic dye represented by formula (15) (to be presented later) was used instead of the magenta dye represented by formula (12), and a mixture of cyan polymethine-based dichroic dyes represented by formulas (16) and (17) (to be presented later) was used instead of the cyan dye represented by formula (13).

FIG. 6 shows the absorption spectrums of the individual colors. In FIG. 6, (A) indicates a yellow absorption spectrum, (B) indicates a magenta absorption spectrum, and (C) indicates a cyan absorption spectrum. Each of these absorption spectrums had a plurality of absorption peaks, and the absorbance of the second largest absorption peak was 80% or more that of the largest absorption peak. The half-widths of these absorption spectrums were 83 nm, 84 nm, and 108 nm.

This liquid crystal display device was driven with a voltage of 2 V and a voltage width of 0.2 V. Consequently, the white-to-black contrast ratio was 3.8 and bright white was displayed by fluorescence of the coumarin dyes. Also, the color quality was satisfactory although black was slightly greenish.

### EXAMPLE 3

A liquid crystal display device was manufactured following the same procedure as in Example 1 except that a yellow perylene-based dichroic dye represented by formula (18) (to be presented later) was used instead of the yellow dye represented by formula (11), a mixture of magenta polymethine-based dichroic dyes represented by formulas (19) and (20) (to be presented later) was used instead of the magenta dye represented by formula (12), and a cyan polymethine-based dichroic dye represented by formula (21) (to be presented later) was used instead of the cyan dye represented by formula (13).

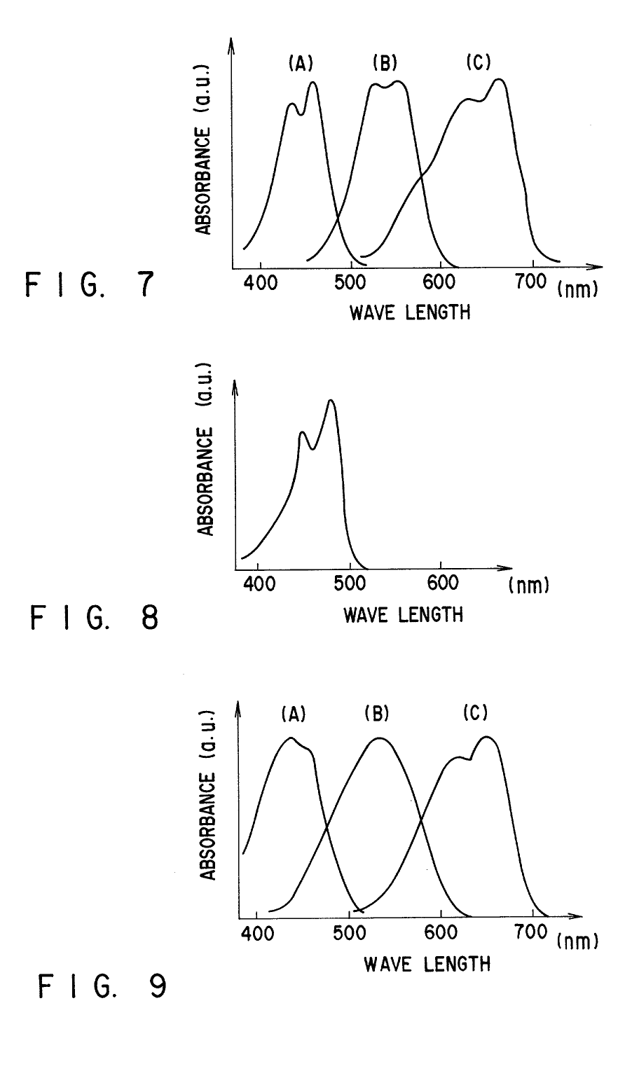

FIG. 7 shows the absorption spectrums of the individual colors. In FIG. 7, (A) indicates a yellow absorption spectrum, (B) indicates a magenta absorption spectrum, and (C) indicates a cyan absorption spectrum. Each of these absorption spectrums had a plurality of absorption peaks, and the absorbance of the second largest absorption peak was 80% or more that of the largest absorption peak. The half-widths of these absorption spectrums were 64 nm, 80 nm, and 110 nm.

This liquid crystal display device was driven with a voltage of 2 V and a voltage width of 0.2 V. Consequently, the white-to-black contrast ratio was 3.3 and bright white was displayed by fluorescence of the perylene dye. Also, the color quality was satisfactory although black was slightly greenish.

### EXAMPLE 4

A liquid crystal display device was manufactured following the same procedure as in Example 1 except that a yellow perylene-based dichroic dye represented by formula (22) (to be presented later) was used instead of the yellow dye represented by formula (11).

FIG. 8 shows the absorption spectrum of yellow. This absorption spectrum had a plurality of absorption peaks, the absorbance of the second largest absorption peak was 80% or more that of the largest absorption peak, and the half-width of the absorption spectrum was 58 nm.

This liquid crystal display device was driven with a voltage of 2 V and a voltage width of 0.2 V. Consequently, the white-to-black contrast ratio was 3.4 and bright white was displayed by the perylene dye. Also, the color quality was satisfactory although black was slightly greenish.

### EXAMPLE 5

A yellow anthraquinone-based dichroic dye represented by formula (23) (to be presented later) was dissolved in STN liquid crystal mixture LIXON4031-000XX containing chiral agent S811. FIG. 9 shows the absorption spectrum of the resultant material. The half-width of this absorption spectrum (A) was 82 nm.

A magenta anthraquinone-based dichroic dye represented by formula (24) (to be presented later) was dissolved in STN liquid crystal mixture LIXON4031-000XX containing chiral agent S811. FIG. 9 shows the absorption spectrum of the resultant material. The half-width of this absorption spectrum (B) was 110 nm.

A cyan polymethine-based dichroic dye represented by formula (25) (to be presented later) was dissolved in STN liquid crystal mixture LIXON4031-000XX containing chiral agent S811. FIG. 9 shows the absorption spectrum of the resultant material. The half-width of this absorption spectrum (C) was 130 nm.

These materials were used to manufacture a liquid crystal display device following the same procedure as in Example 1. When this liquid crystal display device was driven with a voltage of 2 V and a voltage width of 0.2 V, the white-to-black contrast ratio was 2.9 and the color quality was also satisfactory.

### EXAMPLE 6

A yellow coumarin-based dichroic dye represented by formula (11) was dissolved in fluorine-based liquid crystal mixture LIXON5035XX (tradename; available from Chisso Kagaku Kogyo K.K.) The absorption spectrum of the resultant material had a plurality of absorption peaks, and the absorbance of the second largest absorption peak was 80% or more that of the largest absorption peak. The half-width of the absorption peak was 68 nm.

A solution obtained by mixing 80 parts by weight of the above liquid crystal composition, 15 parts by weight of a fluorinated methacrylate monomer, and 0.2 parts by weight of benzoylperoxide was dropped into a solution consisting of 3 parts by weight of a surfactant and 300 parts by weight of pure water and stirred at 1000 rpm at 65° C. , thereby polymerizing the liquid crystal composition. After being polymerized for one hour, the liquid crystal composition was filtered through a filter with a mesh size of 1 μm to separate fine liquid crystal droplets. The resultant liquid crystal droplets were washed with pure water three times and dried to form liquid crystal structures 4 to 6 μm in outside diameter encapsulated in a transparent polymer film (fluorine-based methacrylate film).

Subsequently, the resultant liquid crystal structures and 8 parts by weight of an epoxy prepolymer (epicoat) were mixed. The resultant mixture was dropped into 200 parts by weight of an aqueous 5 wt % solution of gelatin while the solution was kept stirred so that small droplets were formed. Meanwhile, 3 parts by weight of an amine-based hardener were dissolved in 50 parts by weight of water, and the resultant solution was gradually dropped into the above solution under stirring at about 40° C. for one hour. The resultant material was filtered through a filter with a mesh size of 1 μm to separate fine liquid crystal droplets. The resultant liquid crystal droplets were washed with pure water three times and dried to form yellow liquid crystal microcapsules 5 to 7 μm in outside diameter encapsulated in a transparent polymer film (a fluorine-based methacrylate film and an epoxy resin film).

A magenta polymethine-based dichroic dye represented by formula (12) was dissolved in fluorine-based liquid crystal mixture LIXON5035XX (tradename; available from Chisso Kagaku Kogyo K.K.) The absorption spectrum of the resultant material had a plurality of absorption peaks, and the absorbance of the second largest absorption peak was 80% or more that of the largest absorption peak. The half-width of the absorption peak was 85 nm. This material was used to form magenta liquid crystal microcapsules 5 to 7 μm in outside diameter following the same procedure as above.

Also, a cyan polymethine-based dichroic dye represented by formula (13) was dissolved in fluorine-based liquid crystal mixture LIXON5035XX (tradename; available from Chisso Kagaku Kogyo K.K.) The absorption spectrum of the resultant material had a plurality of absorption peaks, and the absorbance of the second largest absorption peak was 80% or more that of the largest absorption peak. The half-width of the absorption peak was 106 nm. This material was used to form cyan liquid crystal microcapsules 5 to 7 μm in outside diameter following the same procedure as above.

FIG. 10A is a schematic view showing a liquid crystal display device according to this example. FIG. 10B is a sectional view of the liquid crystal display device shown in FIG. 10A. In FIGS. 10A and 10B, reference numeral 101 denotes a glass substrate. A plurality of TFTs 102 are formed on the glass substrate 101. An aluminum reflecting plate 103 is arranged on the glass substrate 101 via an insulating film. This reflecting plate 103 forms a pixel electrode. On the reflecting plate 103, a yellow liquid crystal layer 104a, a transparent electrode layer (pixel electrode) 105, a magenta liquid crystal layer 104b, a transparent electrode layer (pixel electrode) 105, and a cyan liquid crystal layer 104c are stacked in this order.

These liquid crystal layers 104a, 104b, and 104care formed by using liquid crystal microcapsules formed by encapsulating guest-host liquid crystals containing dye molecules of the respective colors (yellow, magenta, and cyan) in a transparent polymer film following the procedure described above. That is, the liquid crystal microcapsules are dispersed at a ratio of 10% in an aqueous 10% solution of isopropylalcohol. The dispersion was applied on a glass substrate on which an aluminum reflecting electrode was formed, and was dried. A Teflon plate was pushed against the liquid crystal layer to perform a heat treatment at 120° C. for two hours. Consequently, the liquid crystal layer was adhered to the glass substrate and the epoxy resin was hardened. Thereafter, the resultant structure was cooled to room temperature and the Teflon plate was removed. Note that the liquid crystal layers 104a to 104c can be stacked in any order.

Note also that the transparent electrode layer 105 is formed by sputtering a transparent conductive material on a glass substrate and patterning the material by photolithography and etching, or by patterning a solvent in which a transparent conductive material is dispersed by printing.

Additionally, a glass substrate or a polymer film having a transparent opposing electrode 106 is arranged on the cyan liquid crystal layer 104c. Each TFT is electrically connected to the reflecting plate 103 or the transparent electrode 105.

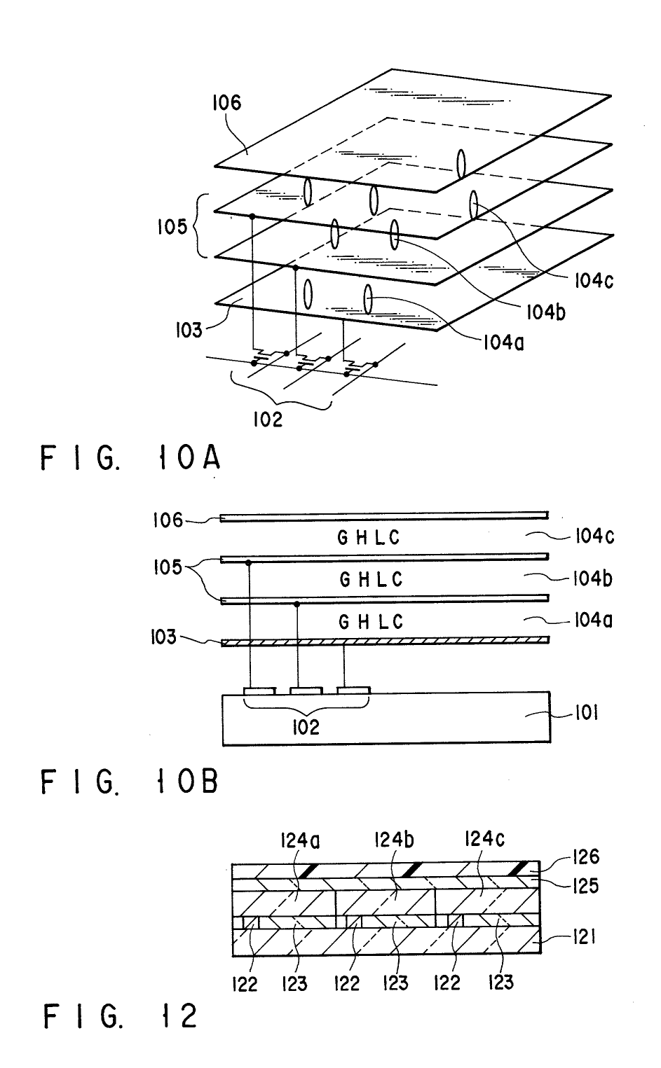

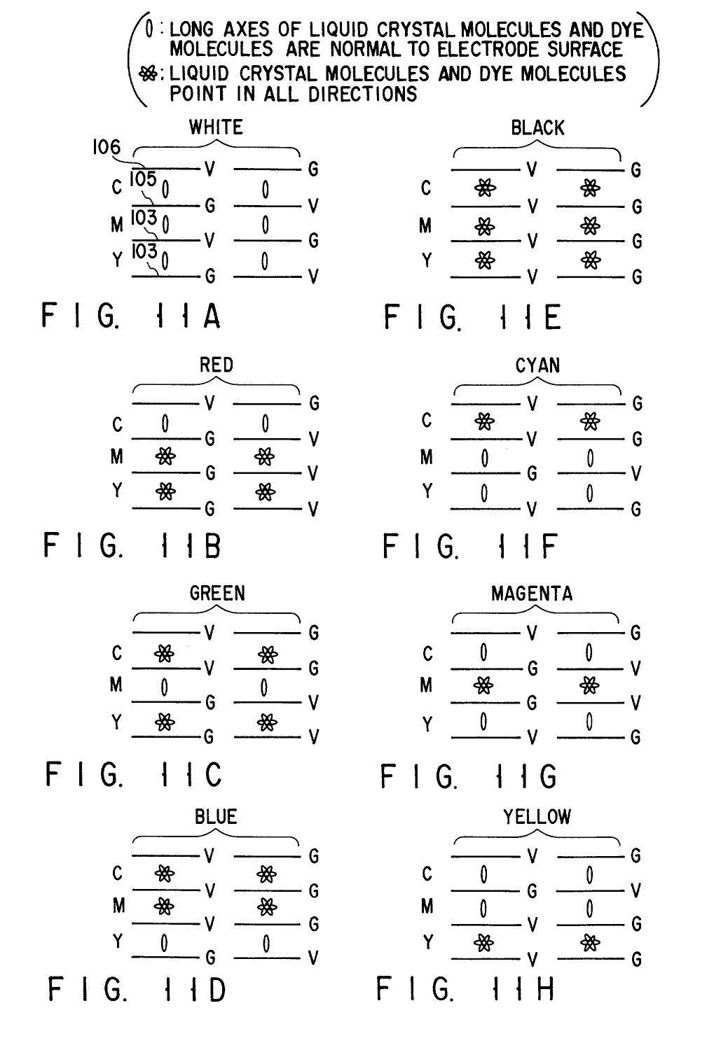

To perform a color display by using this liquid crystal display, the voltages to be applied to the four electrodes sandwiching the liquid crystal layers are previously determined by an arithmetic circuit. To display “white”, for example, the voltages are applied as shown in FIG. 11A. In FIG. 11A, G means GND or a certain reference potential, and V is a potential corresponding to GND, by which the transmittance can be saturated at high level to some extent. Note that two types of voltage applications are shown because it is necessary to apply an AC waveform to the liquid crystal layers. To display “white” by using guest-host liquid crystals, liquid crystal molecules and dye molecules must be raised normal to the electrode surface as much as possible in order to transmit light. Therefore, the voltages were applied as shown in FIG. 11A, and it was possible to well display “white”.

Other colors could be displayed by controlling the voltages between the liquid crystal layers as shown in FIGS. 11B to 11H. This liquid crystal display device was driven with a voltage of 5 V. Consequently, the white-to-black contrast ratio was 4.8 and bright white was displayed by fluorescence of the coumarin dye. Also, the color quality was satisfactory although black was slightly greenish.

### EXAMPLE 7

FIG. 12 is a sectional view showing a liquid crystal display device of this example. In FIG. 12, reference numeral 121 denotes a glass substrate. A plurality of TFTs 122 are formed on the glass substrate 121. An aluminum reflecting plate 123 is arranged on the glass substrate 121 via an insulating film. This reflecting plate 123 forms a pixel electrode. On the reflecting plate 123, a yellow liquid crystal layer 124a, a magenta liquid crystal layer 124b, and a cyan liquid crystal layer 124c are juxtaposed to constitute a liquid crystal layer. These liquid crystal layers 124a, 124b, and 124c are formed by using liquid crystal microcapsules formed by encapsulating guest-host liquid crystals containing dye molecules of the respective colors (yellow, magenta, and cyan) in a transparent polymer film following the same procedure as in Example 6.

A polymer film 126 having a transparent electrode layer 125 is laminated on the liquid crystal layer such that the transparent electrode layer 125 is in contact with the liquid crystal layer. Note that a glass substrate having the transparent electrode layer 125 can also be used instead of the polymer film 126 having the transparent electrode layer 125.

When this liquid crystal display device was driven with a voltage of 5 V, the white-to-black contrast ratio was 3.2 and the color quality was also satisfactory.

### EXAMPLE 8

A yellow anthraquinone-based dichroic dye represented by formula (23), which had an absorption spectrum half-width of 80 nm or more and a function of killing fluorescence, and a fluorescent coumarin-based dichroic dye represented by formula (11), which had an absorption spectrum half-width of 80 nm or less, were dissolved in STN liquid crystal mixture LIXON4031-000XX containing chiral agent S811. The absorption spectrum half-width of the resultant material was 80 nm to 100 nm.

A magenta anthraquinone-based dichroic dye represented by formula (12), which had an absorption spectrum half-width of 80 nm or more and a function of killing fluorescence, and a fluorescent polymethine-based dichroic dye represented by formula (19), which had an absorption spectrum half-width of 80 nm or less, were dissolved in STN liquid crystal mixture LIXON4031-000XX containing chiral agent S811. The absorption spectrum half-width of the resultant material was 80 nm to 110 nm.

A cyan polymethine-based dichroic dye represented by formula (13), which had an absorption spectrum half-width of 80 nm or more, and a polymethine-based dichroic dye represented by formula (17), which had an absorption spectrum half-width of 80 nm or less, were dissolved in STN liquid crystal mixture LIXON4031-000XX containing chiral agent S811. The absorption spectrum half-width of the resultant material was 80 nm to 130 nm.

These materials were used to manufacture a liquid crystal display device following the same procedure as in Example 1. This liquid crystal display device was driven with a voltage of 2 V and a voltage width of 0.2 V. Consequently, the white-to-black contrast ratio was 3.3, the color quality was satisfactory, and black was also well displayed.

### Formulas (11)-(25)

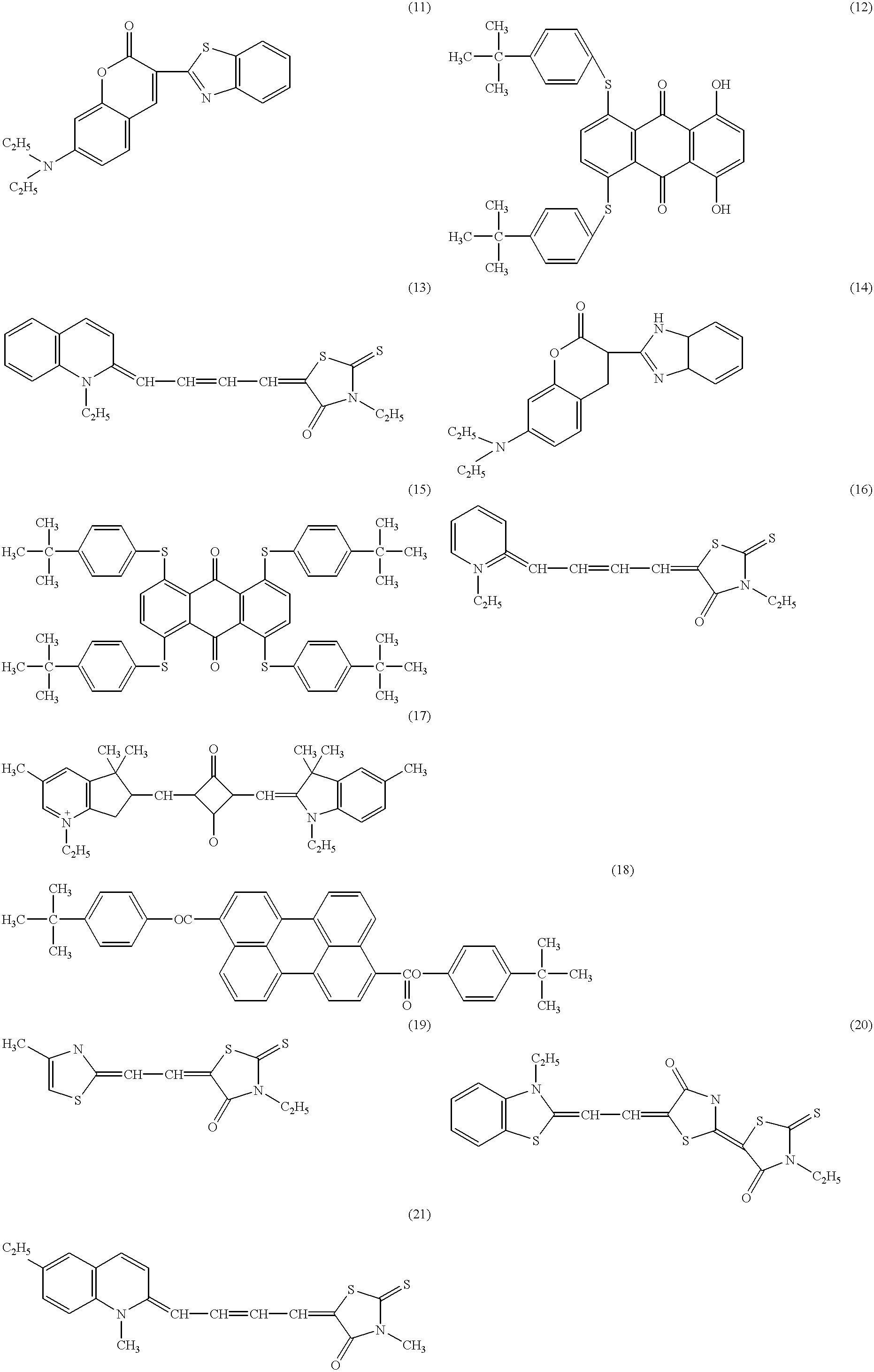

As has been described above, the liquid crystal display device of the present invention is suitable for a color reflection display which simultaneously achieves beautiful colors and high white-to-black contrast. This liquid crystal display device can be used as a display of a low-power-consumption portable apparatus, and its industrial value is enormous.

Additional advantages and modifications will readily occur to those skilled in the art. Therefore, the invention in its broader aspects is not limited to the specific details and representative embodiments, shown and described herein. Accordingly, various modifications may be made without departing from the spirit or scope of the general inventive concept as defined by the appended claims and their equivalents.

1. A liquid crystal display device comprising a yellow guest-host liquid crystal layer, a magenta guest-host liquid crystal layer, and a cyan guest-host liquid crystal layer, wherein an absorption spectrum of each color has at least two absorption peaks, and an absorbance of the second largest absorption peak is not less than 80% of an absorbance of the largest absorption peak.

2. A device according to claim 1, containing a dye whose molar absorption coefficient in a maximum absorption wavelength is not less than 10⁴ 1·cm⁻¹·mol⁻¹.

3. A device according to claim 1, wherein a longest wavelength of a half-width of a yellow absorption spectrum is not more than 500 nm, a wavelength of a half-width of a magenta absorption spectrum exists between 480 nm and 600 nm, and a shortest wavelength of a half-width of a cyan absorption spectrum is not less than 580 nm.

4. A device according to claim 1, wherein each of said color guest-host liquid crystals contains a plurality of types of guest dyes, and a half-width of an absorption spectrum of at least one of said guest dyes is not more than 80 nm.

5. A device according to claim 4, wherein at least one guest-host liquid crystal contains a guest dye whose absorption spectrum half-width is not more than 80 nm and a guest dye whose half-width is larger than 80 nm.

6. A device according to claim 5, wherein said guest dye whose half-width is larger than 80 nm is at least one dye selected from the group consisting of an anthraquinone-based dye and an azo-based dye.

7. A device according to claim 1, wherein a guest dye contained in said color guest-host liquid crystals is only a guest dye whose absorption spectrum half-width is not more than 80 nm.

8. A device according to claim 1, wherein at least one guest-host liquid crystal contains a fluorescent dichroic dye as a guest dye.

9. A device according to claim 1, wherein said guest contains a dye having at least one skeleton selected from the group consisting of a coumarin skeleton, a polymethine skeleton, a perylene skeleton, and an indigo skeleton.

10. A device according to claim 1, wherein each of said yellow, magenta, and cyan liquid crystal layers contains liquid crystal microcapsules formed by encapsulating said guest-host liquid crystal in a transparent polymer film.

11. A device according to claim 1, wherein said host liquid crystal is at least one liquid crystal selected from the group consisting of a fluorine-based liquid crystal, a cyano-based liquid crystal, and an ester-based liquid crystal.

12. A device according to claim 8, wherein said fluorescent dichroic dye is a dye having at least one skeleton selected from the group consisting of a coumarin skeleton, a perylene skeleton, and a polymethine skeleton.

13. A liquid crystal display device comprising a yellow guest-host liquid crystal layer, a magenta guest-host liquid crystal layer, and a cyan guest-host liquid crystal layer, wherein a half-width of an absorption spectrum of yellow is 60 nm to 110 nm, a half-width of an absorption spectrum of magenta is 70 nm to 110 nm, and a half-width of an absorption spectrum of cyan is 80 nm to 130 nm.

14. A device according to claim 13, containing a dye whose molar absorption coefficient in a maximum absorption wavelength is not less than 10⁴ 1·cm⁻¹·mol⁻¹.

15. A device according to claim 13, wherein a longest wavelength of a half-width of a yellow absorption spectrum is not more than 500 nm, a wavelength of a half-width of a magenta absorption spectrum exists between 480 nm and 600 nm, and a shortest wavelength of a half-width of a cyan absorption spectrum is not less than 580 nm.

16. A device according to claim 13, wherein each of said color guest-host liquid crystals contains a plurality of types of guest dyes, and a half-width of an absorption spectrum of at least one of said guest dyes is not more than 80 nm.

17. A device according to claim 16, wherein at least one guest-host liquid crystal contains a guest dye whose absorption spectrum half-width is not more than 80 nm and a guest dye whose half-width is larger than 80 nm.

18. A device according to claim 17, wherein said guest dye whose half-width is larger than 80 nm is at least one dye selected from the group consisting of an anthraquinone-based dye and an azo-based dye.

19. A device according to claim 13, wherein a guest dye contained in said color guest-host liquid crystals is only a guest dye whose absorption spectrum half-width is not more than 80 nm.

20. A device according to claim 13, wherein at least one guest-host liquid crystal contains a fluorescent dichroic dye as a guest dye.

21. A device according to claim 13, wherein said guest contains a dye having at least one skeleton selected from the group consisting of a coumarin skeleton, a polymethine skeleton, a perylene skeleton, and an indigo skeleton.

22. A device according to claim 13, wherein each of said yellow, magenta, and cyan liquid crystal layers contains liquid crystal microcapsules formed by encapsulating said guest-host liquid crystal in a transparent polymer film.

23. A device according to claim 13, wherein said host liquid crystal is at least one liquid crystal selected from the group consisting of a fluorine-based liquid crystal, a cyano-based liquid crystal, and an ester-based liquid crystal.

24. A device according to claim 20, wherein said fluorescent dichroic dye is a dye having at least one skeleton selected from the group consisting of a coumarin skeleton, a perylene skeleton, and a polymethine skeleton.

25. A liquid crystal display device comprising a guest-host liquid crystal layer, wherein said guest-host liquid crystal layer contains, as guest dyes, a fluorescent dichroic dye and a quenching dichroic dye which kills fluorescence resulting from said fluorescent dichroic dye.

26. A device according to claim 25, wherein said guest-host liquid crystal layer comprises a yellow guest-host liquid crystal layer, a magenta guest-host liquid crystal layer, and a cyan guest-host liquid crystal layer.

27. A device according to claim 25, wherein said guest contains a dye having at least one skeleton selected from the group consisting of a coumarin skeleton, a polymethine skeleton, a perylene skeleton, and an indigo skeleton.

28. A device according to claim 25, wherein said liquid crystal layer contains liquid crystal microcapsules formed by encapsulating said guest-host liquid crystal in a transparent polymer film.

29. A device according to claim 25, wherein said host liquid crystal is at least one liquid crystal selected from the group consisting of a fluorine-based liquid crystal, a cyano-based liquid crystal, and an ester-based liquid crystal.

30. A device according to claim 25, wherein said fluorescent dichroic dye is a dye having at least one skeleton selected from the group consisting of a coumarin skeleton, a perylene skeleton, and a polymethine skeleton.

31. A device according to claim 25, wherein said quenching dichroic dye is a dye having at least one skeleton selected from the group consisting of a quinone skeleton and an imide skeleton.
